(19) United States
(12) Patent Application Publication
(10) Pub. No.: US 2011/0135009 A1
(43) Pub. Date: Jun. 9, 2011

(54) COMBINED LOSSY AND LOSSLESS VIDEO COMPRESSION

(75) Inventor: Yukio Sugita, Minato-ku (JP)

(73) Assignee: FUJIFILM CORPORATION, Minato-ku,Tokyo (JP)

(21) Appl. No.: 12/994,415

(22) PCT Filed: May 19, 2009
(86) PCT No.: PCT/JP09/59482

§ 371 Date: Nov. 23, 2010

(30) Foreign Application Priority Data
May 29, 2008 (JP) 2008-140969

(51) Int. Cl. H04N 7/26

(52) U.S. Cl. 375/240.26; 375/E07.2

(57) ABSTRACT

A moving picture compression apparatus includes: a thinning-out processing section which, by selectively taking out numerals from a series of numerals of each image data constituting a compression target data that represents a moving picture by a series of image data each of which represents a still image by a series of numerals, creates a first data comprising a series of numerals which are selectively taken out and a second data comprising a series of remaining numerals for each image data, and shifts positions of numerals which are selectively taken out on the still image from corresponding positions in a temporally adjacent still image. The apparatus further includes: a first compression section which performs lossless compression on the first data; and a second compression section which performs lossy compression on the second data.

### TECHNICAL FIELD

The present invention relates to a moving picture compression apparatus and a storage medium that stores a moving picture compression program for performing a compression processing on data representing a moving picture.

### BACKGROUND ART

With the development of digital technique, various techniques which present a moving picture of digital data and perform filming, recording, reproducing, etc. become widely used.

Although such moving picture data generally has a large amount of data, in many cases it is required that the moving picture is transmitted, for example, in real time in parallel with filming the moving picture or reproducing the moving picture. For this reason, it is required that the data is compressed by using an appropriate compression technique, and some types of moving picture compression techniques are widely used. Recently, there has been also proposed an apparatus which has a function for changing a compression ratio corresponding to the communication speed of data communication and/or a data amount of moving picture data (for example, refer to Patent Document 1).

However, moving picture compression techniques widely used these days are techniques which emphasize the compression ratio, and it cannot be denied that the techniques sacrifice image quality. Therefore, a new compression technique which realizes a high compression ratio while maintaining image quality is desired. It can be considered that moving picture data is compressed by applying image data compression techniques, for example, in Patent Document 2 and Patent Document 3 listed below to each image data representing each of a sequence of still images (frames) which form a moving picture. The technique described in Patent Document 2 is a technique which lossy compresses an image data, and the technique described in Patent Document 3 is a technique which lossless-compresses image data.

### Citation List

Patent Literature

Patent Document 1: Japanese Patent Application Laid-Open No. 2000-261723

Patent Document 2: Japanese Patent Application Laid-Open No. 2003-348359

Patent Document 3: Japanese Patent Application Laid-Open No. 2005-86359

### SUMMARY OF INVENTION

### Technical Problem

It can be expected that the techniques described in Patent Document 2 and Patent Document 3 will achieve both good image quality and good compression ratio to some extent when it is viewed as a technique which compresses image data representing a still image. However, since the moving picture compression techniques widely used these days realize a high compression ratio by using correlatively between frames of a moving picture, etc., even when the techniques described in Patent Document 2 and Patent Document 3 are simply applied to each frame of the moving picture, they cannot necessarily be expected to achieve a high level of both image quality and compression ratio.

It can be considered to achieve both good image quality and good compression ratio by performing a lossy compression on part of frames and performing a lossless compression on the remaining frames, in other words, by dividing time into moments for valuing image quality and moments for valuing compression ratio. However, for example, when storing a video image of a security camera and the like, it is important to reproduce an image of the stable high quality at any moment, and it is desired to achieve both good image quality and good compression ratio at any moment.

The present invention is made in view of the above circumstances, and it is an object of the present invention to provide a storage medium that stores a moving picture compression apparatus and a moving picture compression program which are designed to achieve a high level of both image quality and compression ratio.

### Solution to Problem

A moving picture compression apparatus of the present invention includes:

a thinning-out processing section which, by selectively taking out numerals from a series of numerals of each image data constituting a compression target data that represents a moving picture by a series of image data each of which represents a still image by a series of numerals, creates a first data including a series of numerals which are selectively taken out and a second data including a series of remaining numerals for each image data, and shifts positions of numerals which are selectively taken out on the still image from corresponding positions in a temporally adjacent still image;

a first compression section which performs lossless compression on the first data; and

a second compression section which performs lossy compression on the second data.

In the moving picture compression apparatus according to the present invention, preferably, when the thinning-out processing section selectively takes out numerals, the thinning-out processing section selectively takes out numerals corresponding to positions forming a periodic arrangement on the still image, and the thinning-out processing section does not change a periodicity of the arrangement but changes a phase of the arrangement on a temporally adjacent still image.

Further, in the moving picture compression apparatus according to the present invention, preferably, when the thinning-out processing section selectively takes out numerals, the thinning-out processing section selectively takes out numerals corresponding to positions forming a two-dimensional periodic arrangement on the still image, the thinning-out processing section does not change a periodicity of the arrangement but changes a phase of the arrangement on a temporally adjacent still image, and the thinning-out processing section makes the positions corresponding to the numerals selectively taken out on the still image go around on the still image every predetermined number of image data.

Furthermore, in the moving picture compression apparatus according to the present invention, preferably, the first compression section includes a difference generation section which, by obtaining differences between numerals next to each other in a series of numerals included in the first data, generates differential data including a series of numerals representing the differences, and the first compression section performs a lossless compression on the differential data generated by the difference generation section.

Also, in the moving picture compression apparatus according to the present invention, preferably, the first compression section includes a difference generation section which, by obtaining two-dimensional differences based on multiple numerals adjacent to a numeral in multiple directions on the still image, the numeral being included in the first data, generates differential data including a series of numerals representing the differences, and the first compression section performs a lossless compression on the differential data generated by the difference generation section.

In the moving picture compression according to the present invention, preferably, an image data included in the compression target data is formed by a series of numerals represented by a predetermined number of unit bits, and the second compression section includes:

a determination section which determines an edge portion in the still image; and

a data conversion section which outputs a predetermined code having a number of bits smaller than the number of unit bits when a numeral included in the second data generated in the thinning-out processing section is not the edge portion determined by the determination section, and outputs a numeral represented by a small number of bits smaller than or equal to the number of unit bits when the numeral included in the second data is the edge portion.

Further, in the moving picture compression apparatus according to the present invention, preferably, the data conversion section truncates the least significant digits of the bit value of the number of unit bits when representing a numeral by using the small number of bits.

In the moving picture compression apparatus according to the present invention, preferably, the difference generation section generates differential data including a series of numerals representing the difference by a predetermined number of unit bits as the differential data, and the first compression section includes:

an offset section which offsets each numeral included in differential data generated by the difference generation section by a predetermined value;

a division section which, by dividing each numeral offset by the offset section into the most significant bits and the least significant bits at a predetermined number of division bits smaller than the number of unit bits, divides the data into the most significant data including a series of the most significant bit portion of each numeral and the least significant data including a series of the least significant bit portion of each numeral; and

a most significant data compression section which performs a lossless compression processing on the most significant data divided by the division section.

In the moving picture compression apparatus according to the present invention, preferably, the most significant data compression section includes a first encoding section which directly outputs numerals in the most significant data except for one or more predetermined number of the compression target numerals, and outputs compression target numerals after encoding the compression target numerals into the compression target numeral and a numeral representing the number of a series of the same numerals as the compression target numeral.

In the moving picture compression apparatus according to the present invention, preferably, the most significant data compression section includes:

a first encoding section which directly outputs numerals in the most significant data except for one or more predetermined number of the compression target numerals, and outputs compression target numerals after encoding the compression target numerals into the compression target numeral and a numeral representing the number of a series of the same numerals as the compression target numeral; and

a second encoding section which performs, by using a table which associates codes with numerals, an entropy coding on the data which has been encoded in the first encoding section.

In the moving picture compression apparatus according to the present invention, preferably, the most significant data compression section includes:

a first encoding section which directly outputs numerals in the most significant data except for one or more predetermined number of the compression target numerals, and outputs compression target numerals after encoding the compression target numerals into the compression target numeral and a numeral representing the number of a series of the same numerals as the compression target numeral; and

a second encoding section which performs, by using a Huffman table, a Huffman coding on the data which has been encoded in the first encoding section.

In the moving picture compression apparatus according to the present invention, preferably, the most significant data compression section includes:

a first encoding section which directly outputs numerals in the most significant data except for one or more predetermined number of the compression target numerals, and outputs compression target numerals after encoding the compression target numerals into the compression target numeral and a numeral representing the number of a series of the same numerals as the compression target numeral;

a histogram estimation section which obtains a histogram of numerals appearing in the data which has been encoded in the first encoding section;

a code assignment section which assigns numerals and codes to a table which associates the numerals with the codes, in a condition in which the higher a frequency of appearance of the numeral is, the shorter a length of the code is, based on the obtained histogram; and

a second encoding section which performs, by using the table in which codes are assigned in the code assignment section, an entropy coding on the data which has been encoded in the first encoding section.

The moving picture compression apparatus according to the present invention, preferably, further includes a least significant data compression section which performs a lossless compression on the least significant data divided in the division section.

In the moving picture compression apparatus according to the present invention, preferably, the least significant data compression section performs an entropy coding on the least significant data by using a table which associates numerals with codes.

In the moving picture compression apparatus according to the present invention, preferably, the least significant data compression section performs a Huffman coding on the least significant data by using a Huffman table.

In the moving picture compression apparatus according to the present invention, preferably, the least significant data compression section outputs the least significant data without compression by receiving an instruction to omit compression.

A storage medium of the present invention stores a moving picture compression program which is installed in an information processing apparatus to construct:

a thinning-out processing section which, by selectively taking out numerals from a series of numerals of each image data constituting a compression target data representing a moving picture by a series of image data each of which represents a still image by a series of numerals, makes a first data including a series of numerals which are selectively taken out and a second data including a series of remaining numerals for each image data, and shifts positions of numerals which are selectively taken out in the still image from corresponding positions in a temporally adjacent still image;

a first compression section which performs a lossless compression on the first data; and

a second compression section which performs a lossy compression on the second data.

Although only a basic form of the moving picture compression program of the present invention is described here, this is simply to avoid redundancy, and the moving picture compression program of the present invention includes various forms corresponding to each form of the moving picture compression apparatus.

In addition, regarding an element such as a thinning out processing section which is configured on an information processing apparatus by the moving picture compression program of the present invention, one element may be constructed by one program component, one element may be constructed by plural program components, and plural elements may be constructed by one program component. These elements may be constructed as an element which executes such a processing by itself, or may be constructed as an element which is installed in the information processing apparatus and provides an instruction to another program or program component to execute the processing.

### Advantageous Effects of Invention

According to the moving picture compression apparatus or the storage medium that stores the moving picture compression program of the present invention, in each still image (so-called frame) of a moving picture, data are selectively taken out, the data selectively taken out is lossless compressed to maintain image quality, and remaining data after selectively thinning-out are lossy compressed to achieve high compression ratio. In addition, since thinning-out positions are changed between frames temporally next to each other, in any instant of time in the moving picture, by collecting lossless portions in a sequence of some frames including the instant of time, it is possible to reproduce a high quality image. In short, it is designed to achieve both a good image quality and a good compression ratio at high levels.

When the thinning-out processing section selectively takes out periodic portions on a still image and shifts the periodic phases of still images against each other, the respective areas on a still image are equal to each other in terms of the rate of lossless portion and the respective still images that form a moving picture are equal to each other in terms of the rate of lossless portion, so that, in any place in the moving picture, both a good image quality and a good compression rate are equally achieved.

In addition, when the thinning-out processing section selectively takes out two-dimensional periodic arrangement portions on a still image and makes the portions selectively taken out go around as the moving picture temporally proceeds, by collecting lossless portions in each of frames, the number of which corresponds to one cycle of the going around, it is possible to reproduce an approximately complete still image, and this reproduction can be applied to any instant in the moving picture.

When the first compression section generates a difference to perform a lossy compression, an efficient compression can be expected despite the lossy compression, and both a good image quality and a good compression ratio can be designed in high levels. In addition, when obtaining the difference, if obtaining a two-dimensional difference, a frequency when the difference is zero increases, so that a compression by a lossy compression becomes more efficient.

When the second compression section switches a compression method depending on whether the second data is an edge in the image or not when compressing the second data, by realizing a large scale compression in non-edge portions and withholding a compression at edge portions, the image quality is maintained. In addition, when the data conversion section truncates the least significant digits, a calculation is not necessary, making the conversion easy.

According to a processing mode in which the first compression section includes the division section, etc. and divides the data into the most significant data and the least significant data to process the data, it is possible to perform an appropriate lossless compression separately on each of the most significant data and the least significant data, both of which are notably different from each other in numeral distribution pattern in data, which will be described later in detail, and both a good image quality and a good compression ratio can be designed in high levels. In addition, since the most significant data and the least significant data can be expected to be drastically compressed by using a lossless compression of simple algorism, the processing time is short.

In addition, when the most significant data compression section includes the first encoding section, since only the compression target numeral is encoded into the compression target numeral and a numeral representing the number of continuation, a situation in which redundancy exceeds the original data is avoided, improving the compression ratio.

In addition, when the most significant data compression section includes the second encoding section, a further improvement in compression ratio by entropy coding (typically, Huffman coding) is expected.

Furthermore, when the most significant data compression section includes a histogram calculation section and a code assignment section, and the second encoding section performs entropy coding (for example, Huffman coding) by using a table in which codes are assigned by the code assignment section, the compression ratio can be further greatly improved as compared with entropy coding which uses a table in which code assignments are fixed.

In addition, when the first compression section includes the least significant data compression section, an appropriate lossless compression is performed also on the least significant data, so that the compression ratio is improved.

In addition, when the least significant data compression section performs entropy coding, a further improvement of compression ratio by entropy coding (typically, Huffman coding) is expected.

Furthermore, when the least significant data compression section receives an instruction to omit compression and outputs the least significant data without compression, a faster compression processing can be selected by such an instruction.

### BRIEF DESCRIPTION OF DRAWINGS

### Description of Embodiments

An embodiment of the present invention will be described with reference to the accompanying drawings.

The embodiment described below is, for example, a moving picture compression apparatus in which moving picture data filmed and obtained by a security camera is inputted and a data compression processing is performed on the moving picture data. This moving picture data represents a moving picture constituted by temporal continuation of multiple frames, and each frame represents a still image. A data structure of the moving picture data is a structure in which image data representing still images forming the respective frames are overlapped, and this moving picture compression apparatus receives these image data in order to process the image data.

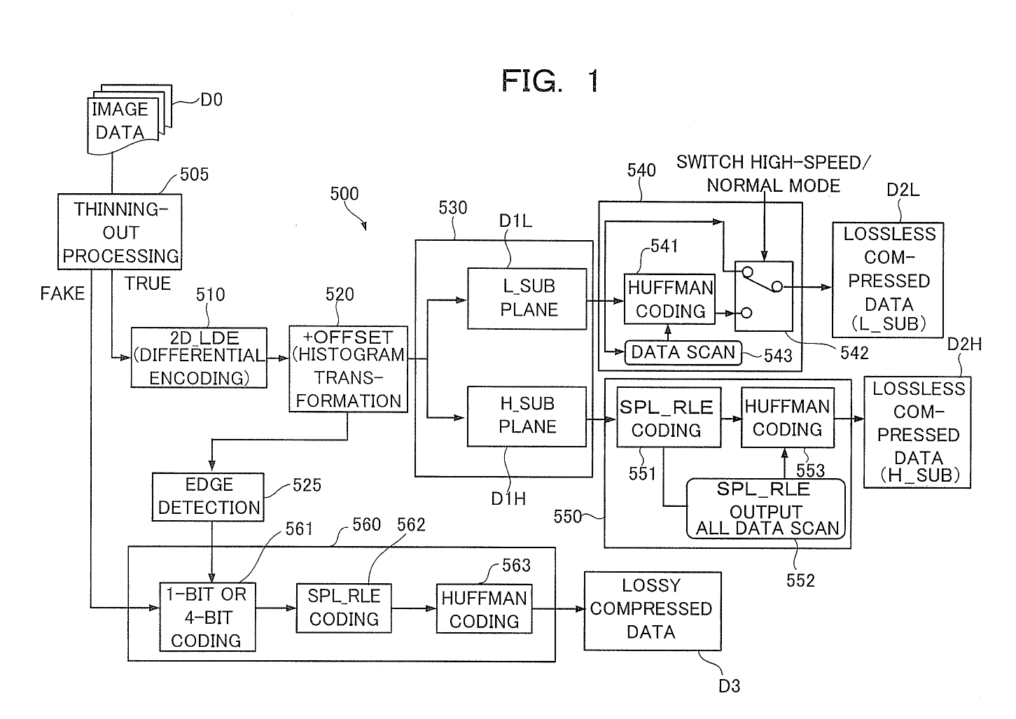

FIG. 1 is a block diagram showing an embodiment of the moving picture compression apparatus of the present invention.

The moving picture compression apparatus 500 illustrated in FIG. 1 is an apparatus constructed on a personal computer which is a kind of information processing apparatus, and includes a thinning-out processing section 505, a differential encoding section 510, an offset section 520, an edge detection section 525, a plane division section 530, an L plane compression section 540, an H plane compression section 550, and a FAKE pixel compression section 560. Although details of the sections 505 to 560 will be described later, a flow of the image data in this moving picture compression apparatus 500 is as follows.

The image data D0 is inputted into the thinning-out processing section 505 of the moving picture compression apparatus 500 illustrated in FIG. 1, and TRUE pixel data corresponding to periodic pixel portions in the image are selectively taken out from the image data. The remaining data after thinning-out becomes the FAKE pixel data. These TRUE pixel data and FAKE pixel data correspond to an example of the first data and an example of the second data of the present invention, respectively.

The TRUE pixel data is inputted into the differential encoding section 510 and a two-dimensional differential encoding processing is performed. Specifically, the two-dimensional differential encoding processing is a processing in which, for a series of numerals constituting the inputted data, by obtaining two-dimensional differences on the image based on multiple numerals adjacent in multiple directions to one of the series of numerals, an image data constituted by a series of 8-bit numerals representing the differences is generated. This differential encoding section 510 corresponds to an example of the difference generation section of the present invention. As the difference generation section of the present invention, although a section which obtains one-dimensional differences in a main scanning direction or a sub-scanning direction may be employed, the differential encoding section 510 which obtains two-dimensional differences is employed in this embodiment.

The image data constituted by a series of numerals representing the differences generated in the differential encoding section 510 is inputted into the offset section 520 and offset by a predetermined value. After that, the image data is inputted into the edge detection section 525 and the plane division section 530. An edge portion of the image is detected based on the offset differential values in the edge detection section 525, and each 8-bit numeral in the image data is divided into least significant 4 bits and most significant 4 bits in the plane division section 530, so that the image data is divided into a least significant sub-plane D1L constituted by a series of the least significant 4-bit numerals and a most significant sub-plane D1H constituted by a series of the most significant 4-bit numerals. The offset section 520 corresponds to an example of the offset section of the present invention, the edge detection section 525 corresponds to an example of the determination section of the present invention, and the plane division section 530 corresponds to an example of the division section of the present invention. And the least significant sub-plane D1L and the most significant sub-plane D1H correspond to an example of the least significant data and an example of the most significant data of the present invention, respectively.

The least significant sub-plane D1L and the most significant sub-plane D1H which are divided in the plane division section 530 are inputted into the L plane compression section 540 and the H plane compression section 550 respectively, and a lossless compression is performed on both sub-planes D1L and D1H. These L plane compression section 540 and H plane compression section 550 correspond to an example of the least significant data compression section and an example of the most significant data compression section of the present invention, respectively.

The L plane compression section 540 includes: a Huffman coding section 541; and a mode switch section 542 that switches the mode to either a high-speed mode or a normal mode; and a data scanning section 543. The least significant sub-plane D1L sent from the plane division section 530 is inputted into both the data scanning section 543 and the Huffman coding section 541.

In the data scanning section 543, all data of the least significant sub-plane D1L is scanned, and a frequency of appearance (histogram) of all the numerals appearing in the data is obtained. Here, in this embodiment, the processing for obtaining the frequency of appearance is executed under such a condition that one least significant sub-plane D1L illustrated in FIG. 1 serves as one unit, and the frequency of appearance of the numerals in the data of each least significant sub-plane D1L is obtained.

In addition, in the data scanning section 543, based on the obtained data histogram (the frequency of appearance of the numerals), the higher the frequency of appearance of a numeral is, the shorter the code assigned to the numeral in the Huffman table is. In this way, the Huffman table in which codes and numerals are associated with each other is updated.

The Huffman table in which codes are assigned to numerals in the data scanning section 543 is sent to the Huffman coding section 541. Subsequently, in the Huffman coding section 541 of the L plane compression section 540, according to the sent

Huffman table, a Huffman encoding processing in which the numerals constituting the least significant sub-plane D1L inputted into the Huffman coding section 541 are replaced by the codes in accordance with the Huffman table is performed. This Huffman encoding processing is a kind of entropy coding processing. The table for encoding used in the Huffman encoding processing (entropy coding processing) may be a table based on the scanning as described above or may be a fixed table.

The data which has been encoded in the Huffman coding section 541 is accompanied by compression information including an assignment table of the numerals and codes assigned in the data scanning section 543, and becomes least significant compressed data D2L which is compressed data of the least significant sub-plane D1L. The mode switch section 542 is embedded in the L plane compression section 540, and this mode switch section 542 is instructed to switch a high-speed mode and a normal mode by a user and switches the normal mode in which the Huffman coding is performed by the Huffman coding section 541 and the high-speed mode in which the Huffman coding is omitted and the least significant sub-plane D1L is directly outputted. From such L plane compression section 540, the least significant compressed data D2L which is compressed data of the least significant sub-plane D1L is outputted. However, when in the high-speed mode, the least significant compressed data D2L is the least significant sub-plane D1L itself.

On the other hand, the H plane compression section 550 includes the run length coding section 551, the data scanning section 552, and the Huffman coding section 553. The most significant sub-plane D1H is inputted into the run length coding section 551.

In the run length coding section 551, first, from the inputted most significant sub-plane D1H, one or more compression target numeral or a series of same compression target numerals are detected. Next, in the run length coding section 551, in response to the detection result, from the most significant sub-plane D1H data, numerals except for the compression target numerals are directly outputted and the compression target numeral is encoded into numerals representing the compression target numeral and the number of a series of the same compression target numerals as the compression target numeral. In the run length coding section 551, when performing the encoding processing, corresponding to the number of a series of the same compression target numerals, the number is encoded to be represented by the different number of bits. Here, specifically, when the number of a series of the same compression target numerals is less than or equal to a predetermined number, the number is represented by one-unit-bit number, and when the number of a series of the same compression target numerals is more than a predetermined number, the number is represented by two-unit-bit number. In this embodiment, this run length coding section 551 corresponds to an example of the first encoding section of the present invention.

The data encoded in the run length coding section 551 is inputted into both the data scanning section 552 and the Huffman coding section 553. In the data scanning section 552, all the data encoded in the run length coding section 551 is scanned, and a frequency of appearance (histogram) of all the numerals appearing in the data is obtained. Here, in this embodiment, the processing for obtaining the frequency of appearance is executed under such a condition that one most significant sub-plane D1H illustrated in FIG. 1 serves as one unit, and the frequency of appearance of the numerals in the encoded data of each most significant sub-plane D1H is obtained, each most significant sub-plane D1H being encoded in the run length coding section 551. In addition, in the data scanning section 552, based on the obtained data histogram (the frequency of appearance of the numerals), the higher the frequency of appearance of a numeral is, the shorter the code assigned to the numeral in the Huffman table is. This data scanning section 552 is an example of the histogram estimation section and also an example of the code assignment section of the present invention.

The Huffman table in which codes are assigned to numerals in the data scanning section 552 is sent to the Huffman coding section 553, and in the Huffman coding section 553, according to the sent Huffman table, an encoding processing in which the numerals constituting the data inputted into the Huffman coding section 553 are replaced by the codes in accordance with the Huffman table, specifically, a numeral having a higher frequency of appearance is replaced by a code represented by a shorter bit-length is performed. This Huffman coding section 553 corresponds to an example of the second encoding section of the present invention.

The data which has been encoded in the Huffman coding section 553 is accompanied by compression information including an assignment table of the numerals and codes assigned in the data scanning section 552, and outputted from the H plane compression section 550 as most significant compressed data D2H which is compressed data of the most significant sub-plane D1H.

A pair of the least significant compressed data D2L and the most significant compressed data D2H outputted respectively from the L plane compression section 540 and H plane compression section 550 in this way constitutes a lossless compressed data which is a lossless compressed data of the TRUE pixel data.

On the other hand, the FAKE pixel data obtained in the thinning-out processing section 505 is inputted into the FAKE pixel compression section 560, and a lossy compression is performed on the FAKE pixel data. This FAKE pixel compression section 560 includes the bit shortening section 561, the run length coding section 562, and the Huffman coding section 563, and the numerals constituting the FAKE pixel data are replaced by codes of 1 bit or 4 bits in the bit shortening section 561. At this time, a code replacement method varies depending on whether the pixel is a pixel corresponding to an edge portion detected in the edge detection section 525 or not. After the FAKE pixel data is replaced by codes of 1 bit or 4 bits in this way, the same processing as that of the H plane compression section 550 is performed by the run length coding section 562 and the Huffman coding section 563. As a result, the lossy compressed data D3 which is a lossy compressed data of the FAKE pixel data is outputted from the FAKE pixel compression section 560.

Compressed data corresponding to original image data representing a still image of a frame is constituted by the lossless compressed data of the TRUE pixel data and the lossy compressed data of the FAKE pixel data. And compressed data of moving picture data is constituted by a series of compressed data corresponding to a series of frames. Such compressed data of the moving picture may be transmitted via a communication line or stored in a recording medium. And a decompression processing is performed on the compressed data in a transmission destination or a reproducing device, and used to display a moving picture, etc. In this data decompression processing, decoding processes corresponding to various kinds of encoding processes described in FIG. 1 are performed, a series of image data sufficiently approximated to a series of image data representing the original moving picture are reproduced, and the original moving picture is reproduced with high image quality. Furthermore, for example, when required for a security reason, the compressed data is used to reproduce an approximately the same still image as the original still image at a desired instant of the moving picture.

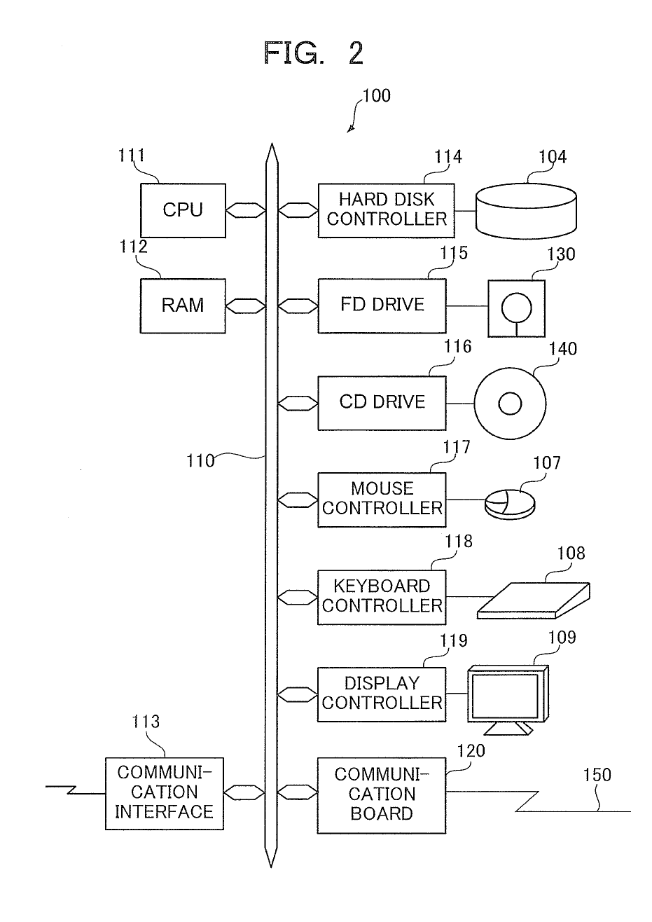

FIG. 2 is a hardware configuration diagram of a personal computer on which the moving picture compression apparatus 500 illustrated in FIG. 1 is constructed.

The personal computer 100 illustrated in FIG. 2 includes a CPU 111, a RAM 112, a communication interface 113, a hard disk controller 114, a FD drive 115, a CD drive 116, a mouse controller 117, a keyboard controller 118, a display controller 119, and a communication board 120, and these components are connected by a bus 110.

The hard disk controller 114 controls access of a hard disk 104 built in this personal computer 100. The FD drive 115 and the CD drive 116 access a flexible disk (FD) 130 removably inserted in the personal computer 100 and a CD type medium 140 represented by CD-ROM. The mouse controller 117 and the keyboard controller 118 have roles to detect operations of a mouse 107 and a keyboard 108 provided to the personal computer 100 and transmit the operations to the CPU 111. In addition, the display controller 119 has a role to display an image on a display screen of an image display 109 provided to the personal computer 100 based on an instruction of the CPU 111.

The communication board 120 is in charge of communication compliant with a general interface protocol such as SCSI, and has a role to transmit moving picture data which has been compressed to other devices via an interface cable 150.

In addition, the communication interface 113 is in charge of general communication such as the Internet, and the personal computer 100 can also transmit moving picture data via this communication interface 113.

A program stored in the hard disk 104 is read out and developed in the RAM 112 so that the CPU 111 executes the program. The CPU 111 reads out the program developed in the RAM 112 and executes the program.

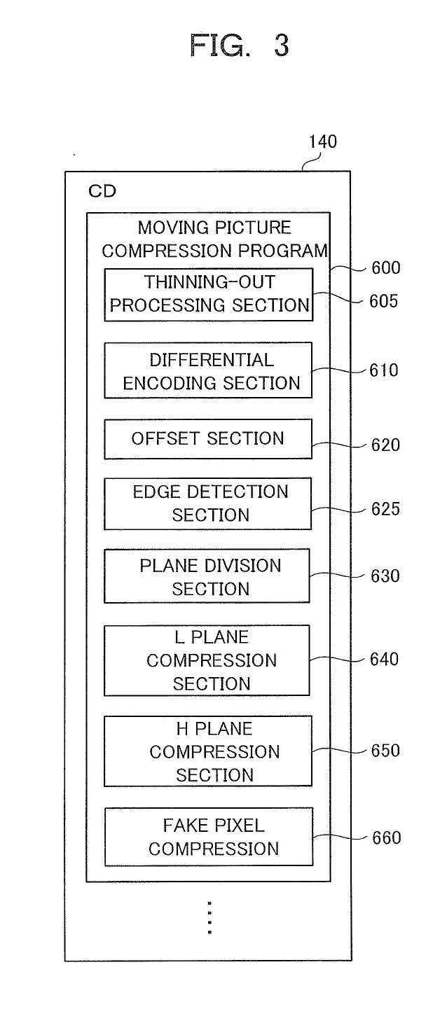

FIG. 3 is a schematic diagram of an image compression processing program corresponding to an embodiment of the moving picture compression program of the present invention.

Here, this moving picture compression program 600 is stored in the CD type medium 140. However, as for a storage medium storing the moving picture compression program of the present invention, any type of medium can be used as long as the medium can store the program. For example, a magnetic disk in a hard disk device can be used, or a flexible disk, an MO disk, and a DVD can be also used, or a card type storage medium and a tape type storage medium can be also used. In addition, the moving picture compression program of the present invention is not limited to a program stored in a storage medium, but the moving picture compression program may be a program communicated via a communication line.

The moving picture compression program 600 includes a thinning-out processing section 605, a differential encoding section 610, an offset section 620, an edge detection section 625, a plane division section 630, an L plane compression section 640, an H plane compression section 650, and a FAKE pixel compression section 660.

This CD type medium 140 illustrated in FIG. 3 is mounted in the personal computer 100 illustrated in FIG. 2, and accessed by the CD drive 116. And the program stored in the CD type medium 140 is uploaded to the personal computer 100, and stored in the hard disk 104. When the program stored in the hard disk 104 is read out from the hard disk 104, developed in the RAM 112, and executed by the CPU 111, this personal computer 100 operates as the moving picture compression apparatus 500 illustrated in FIG. 1.

Here, the moving picture compression program 600 illustrated in FIG. 3 is installed in the personal computer 100 and executed by the CPU 111, so that the moving picture compression apparatus 500 illustrated in FIG. 1 is realized in the personal computer 100. When the CPU 111 executes the thinning-out processing section 605, the differential encoding section 610, the offset section 620, the edge detection section 625, the plane division section 630, the L plane compression section 640, the H plane compression section 650, and the FAKE pixel compression section 660, the above sections operates as program components to operate the personal computer 100 as the moving picture compression apparatus 500 by respectively operating the thinning-out processing section 505, the differential encoding section 510, the offset section 520, the edge detection section 525, the plane division section 530, the L plane compression section 540, the H plane compression section 550, and the FAKE pixel compression section 560 which configure the moving picture compression apparatus 500 illustrated in FIG. 1. In short, by using these program components, configuration elements of the moving picture compression apparatus 500 are virtually constructed in the personal computer 100.

The operations when the CPU 111 executes the components 605 to 660 which configure the moving picture compression program 600 illustrated in FIG. 3 are the operations of the components 505 to 560 which configure the moving picture compression apparatus 500 illustrated in FIG. 1. Therefore, the above description and detail description which will be given below of the components 505 to 560 of the moving picture compression apparatus 500 illustrated in FIG. 1 will also serve as descriptions of the components 605 to 660 configuring the moving picture compression program 600 illustrated in FIG. 3.

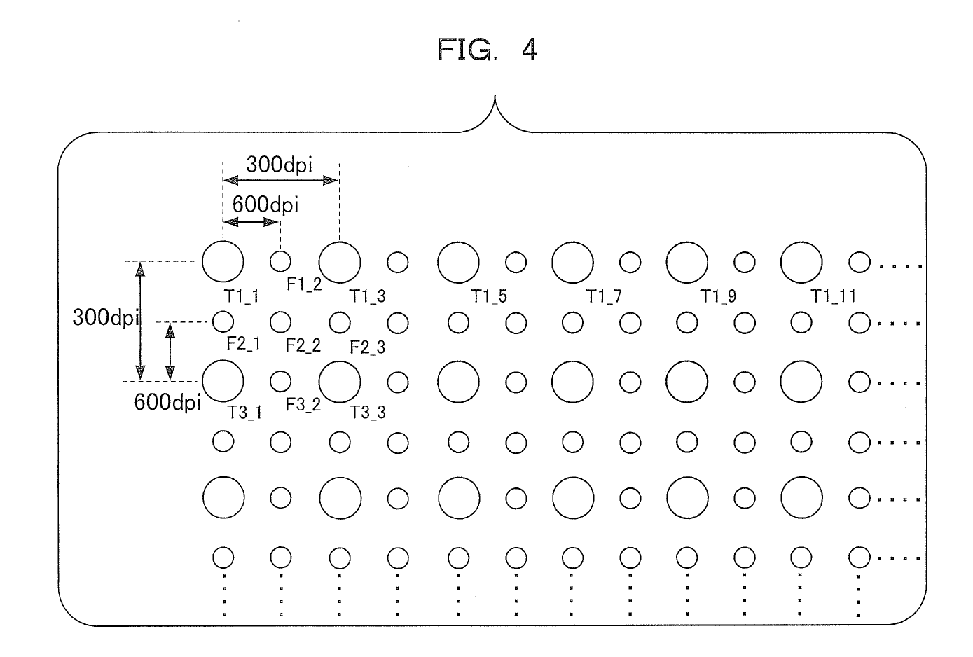

FIG. 4 is a diagram showing the concept of a data structure of image data inputted into the moving picture compression apparatus 500 illustrated in FIG. 1 and thinning-out processing.

As illustrated in FIG. 4, in the image data inputted into the moving picture compression apparatus 500 illustrated in FIG. 1, pixels are aligned in a predetermined main scanning direction (horizontal direction in the figure) and a sub-scanning direction (vertical direction in the figure) at a right angle to the main scanning direction, and a pixel row aligned in the main scanning direction is called a line. Here, 8 lines of pixels are illustrated, and a distance between the pixels corresponds to a resolution of 600 dpi.

The location of a pixel is represented by a suffix attached to the symbol T or F representing a pixel value. For example, in the third line, suffixes 3_{—}1, 3_{—}2, 3_{—}3, 3_{—}4, . . . are attached to pixel values of the respective pixels aligned in the main scanning direction, in the alignment order.

Image data constituted by pixel values aligned like this is inputted into the thinning-out processing section 505 of the moving picture compression apparatus 500 illustrated in FIG. 1, and each pixel is divided into TRUE pixels and FAKE pixels. As for each pixel illustrated in FIG. 4, the TRUE pixels are represented by a pixel value of symbol T and the FAKE pixels are represented by a pixel value of symbol F. The TRUE pixels are pixels which are periodically selectively taken out from the pixel alignment. Here, for example, in one of every two lines (odd numbered line) in the sub-scanning direction, one of every two pixels (odd numbered pixel) in the main scanning direction is selectively taken out as a TRUE pixel. As a result, in the example illustrated in FIG. 4, the TRUE pixels correspond to pixels constituting an image whose resolution is decreased from original 600 dpi to 300 dpi, and pixels corresponding to one fourth of pixels of the original image data are selectively taken out. The TRUE pixels taken out in this way constitute TRUE pixel data including a series of such TRUE pixels, and the structure of the TRUE pixel data is a structure in which pixels are aligned in the main scanning direction and sub-scanning direction like the original image data. The remaining FAKE pixels after the TRUE pixels are taken out constitute FAKE pixel data including a series of the FAKE pixels.

As taking-out methods of TRUE pixels, other than the above, for example, a method in which pixels are taken out from one of every three pixels in the main scanning direction and form one of every three lines in the sub-scanning direction, thereby pixels corresponding to one ninth of pixels of the original image data are selectively taken out may be employed, and a method in which a taking out frequency in the main scanning direction is different from the sub-scanning direction can be employed. However in the description below, it is assumed that odd numbered pixels in odd numbered lines are selectively taken out.

The frequency in which the thinning-out processing section 505 takes out the TRUE pixels is the same for each frame of a moving picture. However, positions (phases) where pixels are taken out vary among the frames.

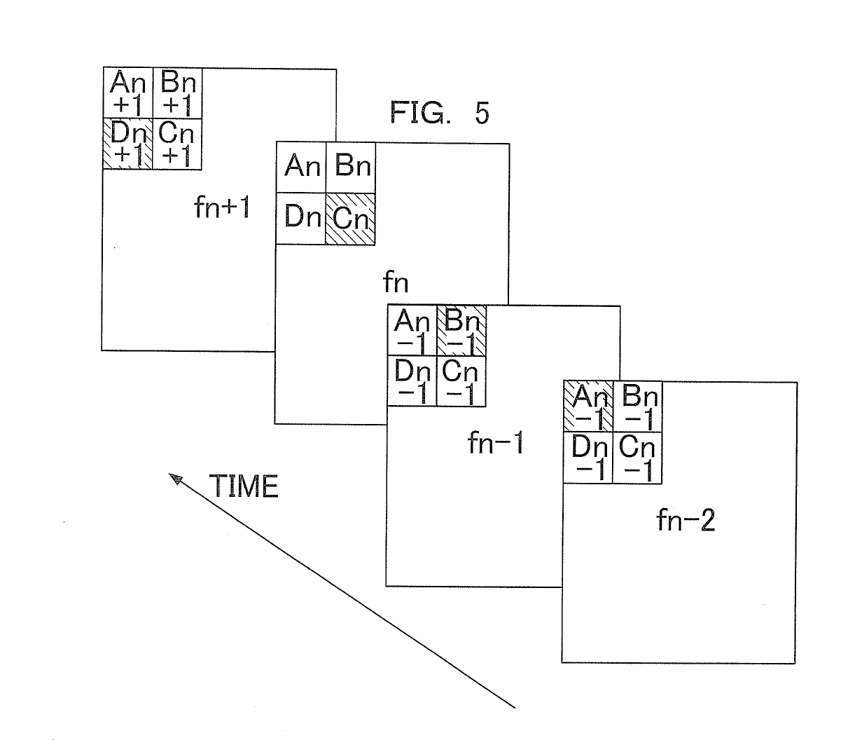

FIG. 5 is a view for illustrating varying positions where pixels are selectively taken out in each frame.

In FIG. 5, a view in which frames fn−2, fn−1, fn, fn+1 which constitute a moving picture are aligned along a time axis is conceptually illustrated. In the upper left portion of each frame fn−2, fn−1, fn, fn+1, 4 pixels per frame, An−2, Bn−2, Cn−2, Dn−2; An−1, Bn−1, Cn−1, Dn−1; An, Bn, Cn, Dn; An+1, Bn+1, Cn+1, Dn+1 are illustrated. These pixels are located in the same position (upper left portion) on the image of each of the frames fn−2, fn−1, fn, fn+1 which are aligned temporally next to each other, and correspond to the 4 pixels T1_1, F1_2, F2_1, F2_2 illustrated at upper left portion of the data structure illustrated in FIG. 4. In the data structure illustrated in FIG. 4, the upper left pixel T1_1 of the 4 pixels T1_1, F1_2, F2_1, F2_2 is the TRUE pixel. On the other hand, in each frame fn−2, fn−1, fn, fn+1 illustrated in FIG. 5, a shaded pixel of 4 pixels illustrated in one frame is the TRUE pixel. In short, the positions of TRUE pixels on frames temporally next to each other are different, and the position of TRUE pixel moves 1 pixel or 1 line every frame. As a result, the position of TRUE pixel goes around clockwise on the image every 4 frames as time goes on. Such movement of the TRUE pixel is the same for all the TRUE pixels on the image. Therefore, an alignment frequency of the TRUE pixels does not change, and only an alignment phase changes every frame. As will be mentioned later, although a lossless compression is performed on the TRUE pixel data including a series of TRUE pixels, and a lossy compression is performed on the FAKE pixel data including a series of FAKE pixels, when the position of TRUE pixel moves as illustrated in FIG. 5, temporally averaged image quality of each pixel on the image is homogenized. There is a moment when data is lossless-compressed in every pixel on the image, and by collecting such lossless data portions from frames while the TRUE pixel goes around (for example, 4 frames as illustrated in FIG. 5), a still image of approximately the same quality can be reproduced at any moment of the moving picture.

Hereinafter, the lossless compression for the TRUE pixel data will be described.

In the lossless compression, at first, the TRUE pixel data is inputted into the differential encoding section 510 included in the moving picture compression apparatus 500 illustrated in FIG. 1, a two-dimensional differential encoding processing is performed on the TRUE pixel data, and further differences in the sub-scanning direction are obtained from differences of pixels next to each other in the main scanning direction.

This two-dimensional differential encoding processing will be specifically described.

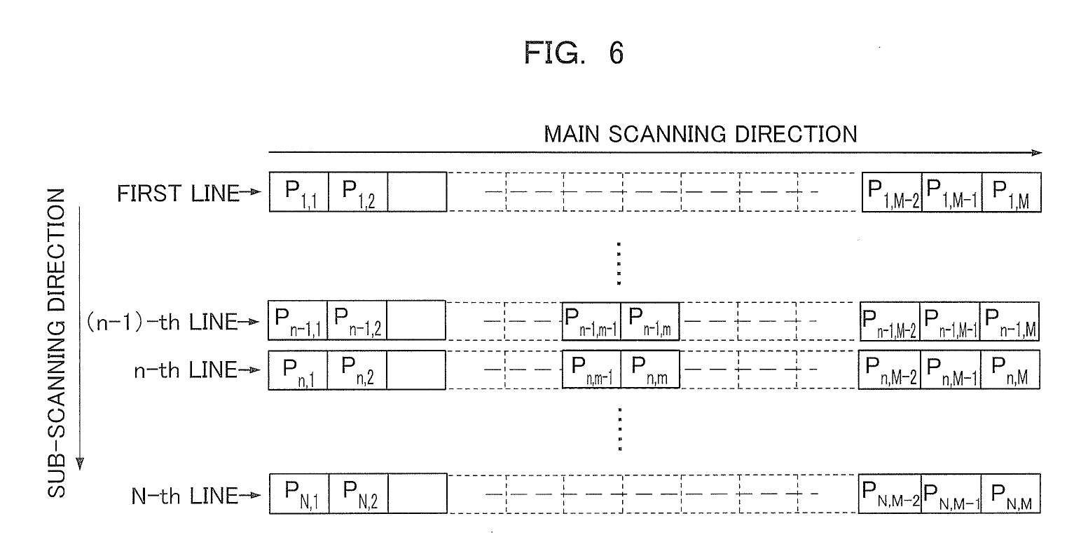

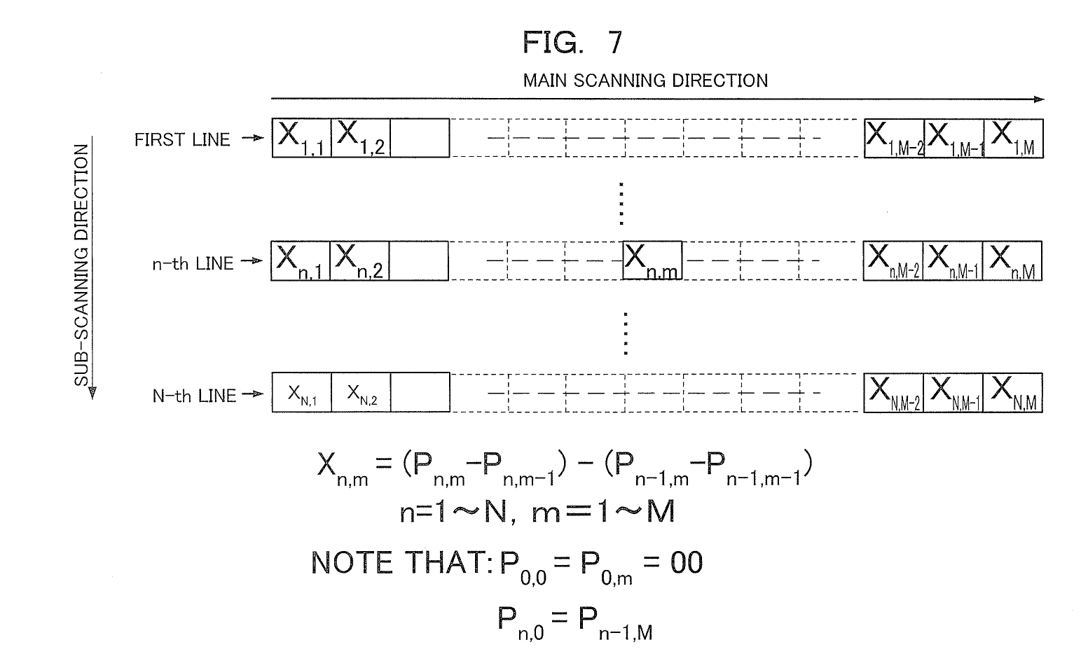

FIG. 6 is a diagram showing a structure of the TRUE pixel data inputted into the differential encoding section 510, and FIG. 7 is a diagram showing a structure of the TRUE pixel data after the two-dimensional differential encoding processing is performed on the TRUE pixel data.

As mentioned above, the TRUE pixel data represents a low resolution image made of pixels selectively taken out from the image, and the TRUE pixel data is a kind of image data. The image represented by the TRUE pixel data is constituted by arranging N lines, in each of which M pixels are aligned in a predetermined main scanning direction, in the sub-scanning direction at a right angle to the main scanning direction. Reflecting such constitution, as illustrated in FIG. 6, the image data also has a structure in which N lines, in each of which M pixels are aligned in the main scanning direction (left-right direction in the figure), are arranged in the sub-scanning direction (up-down direction in the figure). In FIG. 6, the pixel value of the m-th pixel from the left in the n-th line from the top is represented by Pn, m, and using this notation, the pixel values of pixels aligned in the main scanning direction in the n-th line in the sub-scanning direction are represented in order by:

Pn, 1, Pn, 2, . . . , Pn, m−1, Pn, m, . . . , Pn, M−2, Pn, M−1, Pn, M.

These pixel values are numerals represented in hexadecimal notation.

Here, the image data as mentioned above is inputted into the differential encoding section 510 illustrated in FIG. 1, a two-dimensional differential encoding processing is performed on the image data, and further differences in the sub-scanning direction are obtained from differences of pixels next to each other in the main scanning direction.

FIG. 7 shows a structure of data on which two-dimensional differential encoding processing is performed, and this data also has a structure in which N lines, in each of which M pixel values after the two-dimensional differential encoding processing are aligned in the main scanning direction, are arranged in the sub-scanning direction. In this figure, the pixel value, on which two-dimensional differential encoding processing is performed, of the m-th pixel from the left in the n-th line from the top is represented by Xn, m, and this pixel value Xn, m is obtained from 4 pixel values {Pn−1, m−1, Pn−1, m, Pn, m−1, Pn, m} before two-dimensional differential encoding processing by using the following conversion formula:

Xn, m=(Pn, m−Pn, m−1)−(Pn−1, m−Pn−1, m−1) (1)

Here, when n=1 and m=1, 0 appears as a suffix of a pixel value of right-side which is before two-dimensional differential encoding. A pixel value having a suffix of 0 is defined as follows:

P0, 0=P0, m=00 (m=1 to M), Pn, 0=Pn−1, M (n=1 to N) (2)

Here, “00” in formula (2) shows that the pixel value is zero in hexadecimal notation. Hereinafter, the meanings of the formula (1) and formula (2) will be briefly described.

The formula (1) shows that the pixel value Xn, m after two-dimensional differential encoding can be obtained by a further difference in the sub-scanning direction which is obtained from differences (in short, values in parentheses) between pixels next to each other in the main scanning direction. When the pixel value Pn, m before two-dimensional differential encoding has a strong correlation with a neighboring pixel (in short, having approximately the same size of pixel value), the pixel value Xn, m after two-dimensional differential encoding becomes near zero.

The formula (2) is a formula showing a definition of each pixel value when newly providing a virtual 0-th line in the sub-scanning direction and a virtual 0-th pixel from the left in each line. In the main scanning direction, it is defined that the left end pixel value (0-th pixel value from the left, Pn, 0) is assumed to be the same as the pixel value Pn−1, M which is the right end pixel value in the previous line. In the sub-scanning direction, it is defined that the upper most pixel values in the figure (pixel values on the 0-th line), specifically, P0, 0, and P0, m are fixed to 0.

In the data after two-dimensional differential encoding, since a suffix “0” appears in the right-side of formula (1) for the pixel values in the first line and the first pixel value in each line, the definition of formula (2) is applied. Specifically, by using the above formulas (1) and (2), pixel values in the first line after two-dimensional differential encoding are as follows:

$$X 1 , 1 = P 1 , 1$$

$$X 1 , 2 = P 1 , 2 - P 1 , 1$$

$$X 1 , 3 = P 1 , 3 - P 1 , 2$$

$$…$$

$$X 1 , M = P 1 , M - P 1 , M - 1.$$

On the other hand, in the data after two-dimensional differential encoding, by using the above formula (2), the first pixel values in the respective lines are as follows:

$$X 1 , 1 = P 1 , 1$$

$$X 2 , 1 = ( P 2 , 1 - P 1 , M ) - P 1 , 1$$

$$X 3 , 1 = ( P 3 , 1 - P 2 , M ) - ( P 2 , 1 - P 1 , M )$$

$$…$$

$$X N , 1 = ( PN , 1 - PN - 1 , M ) - ( PN - 1 , 1 - PN - 2 , M ) .$$

Although the conversion method is relatively complicated for pixel values in the first line and the first pixel values in each line as mentioned above, for pixels other than these pixels, the definition of formula (2) is not applied and the formula (1) is directly applied. For example, pixel values except for the left end pixel value in the second line are as follows:

$$X 2 , 2 = ( P 2 , 2 - P 2 , 1 ) - ( P 1 , 2 - P 1 , 1 )$$

$$X 2 , 3 = ( P 2 , 3 - P 2 , 2 ) - ( P 1 , 3 - P 1 , 2 )$$

$$…$$

$$X 2 , M = ( P 2 , M - P 2 , M - 1 ) - ( P 1 , M - P 1 , M - 1 ) .$$

This two-dimensional differential encoding processing will be described by using specific numerals.

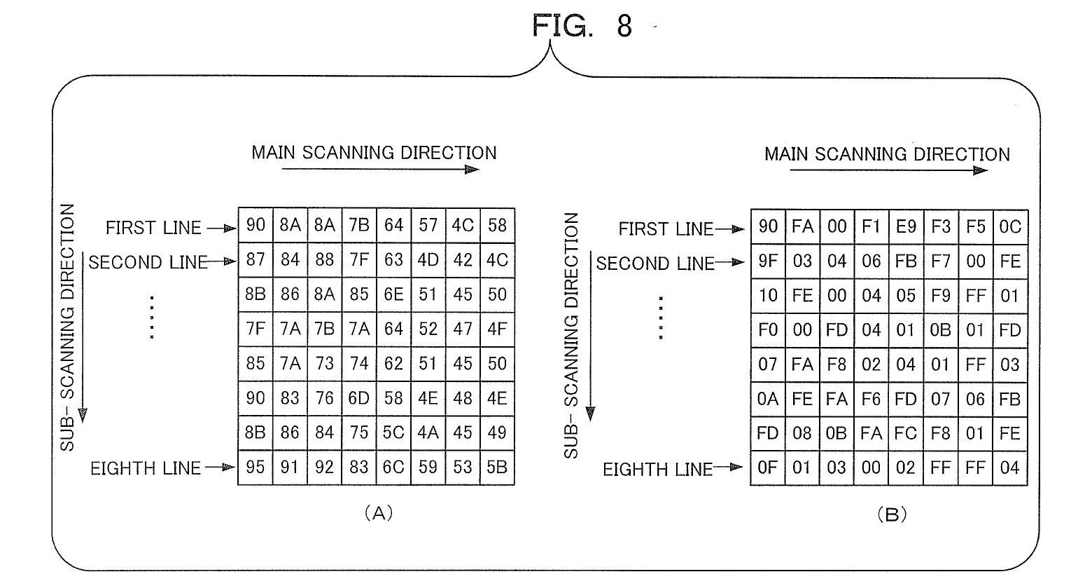

FIG. 8 is a diagram for illustrating the two-dimensional differential encoding processing in the differential encoding section 510 illustrated in FIG. 1.

Each numeral illustrated in the left side (part (A)) in this figure is a pixel value of an image data, and each numeral illustrated in the right side (part (B)) in this figure is an output value outputted from the two-dimensional differential encoding processing. The horizontal direction in this figure is the main scanning direction, and an alignment of 8 numerals aligned in the main scanning direction is the line. In the data illustrated in this figure, there are 8 lines in total in each of which such 8 numerals are aligned, and the data corresponds to the data in FIGS. 6 and 7 in a case of N=8 and M=8.

In a two-dimensional differential encoding processing of the data illustrated in part (A) of FIG. 8, first, the left end “90” of the first line pixel values “90 8A 8A 7B . . . ” is directly outputted as this value corresponds to the above X1, 1, and for the other X1, 2, X1, 3, . . . , the difference values between pixel values next to each other in the main scanning direction “8A-90=FA”, “8A-8A=00”, . . . are outputted. Here, the result of subtracting “90” from “8A” is actually a negative value, and represented as “1FA” by using 9 bits. However, the most significant bit “1” which is 1 bit of MSB is omitted and only the least significant 8 bits “FA” is outputted.

For the second line, in the formula to obtain X2, 1: X2, 1=(P2, 1−P1, M)−P1, 1, the numerals illustrated in part (A) of FIG. 8 are assigned to {P2, 1, P1, 8, P1, 1} of the right-side in a case of M=8, and” (87−58)−90=9F” is outputted as X2, 1. Other than the above, for X2, 2, X2, 3, . . . , further differences between pixel values next to each other in the main scanning direction in the second line and a difference between pixel values next to each other in the main scanning direction in the first line, specifically “(84−87)−(8A−90)=03”, “(88−84)−(8A−8A)=04” . . . are outputted.

For the third line, in the formula to obtain X3, 1: X3, 1=(P3, 1−P2, M)−(P2, 1−P1, M), the numerals illustrated in part (A) of FIG. 8 are assigned to {P3, 1, P2, 8, P1, 8} of the right-side in a case of M=8, and “(8B−4C)−(87−58)=10” is outputted as X3, 1. Other than the above, for X3, 2, X3, 3, . . . , further differences between pixel values next to each other in the main scanning direction in the third line and a difference between pixel values next to each other in the main scanning direction in the second line, specifically “(86−8B)−(84−87)=FE”, “(8A−86)−(88−84)=00” . . . are outputted.

Like the above, for the fourth and further lines, by repeating the same calculation as that of the third line, each numeral illustrated in part (B) of FIG. 8 can be obtained.

In decompression processing for compressed moving picture data, encoding processing is performed on these data encoded by two-dimensional differential encoding. In this encoding processing, a formula to obtain Pn, m from values of data encoded by two-dimensional differential encoding is used. This formula can be obtained as follows.

The pixel values Xi, j after two-dimensional differential encoding are summed up from i=1 to i=m, and furthermore summed up from j=1 to j=m. The result is represented as the formula (3) below by using the formula (1) and the formula (2).

$$\begin{matrix}{\sum }_{i = 1}^{n} {\sum }_{j = 1}^{m} {X}_{i , j} = {\sum }_{i = 1}^{n} \{ {\sum }_{j = 1}^{m} ( {p}_{i , j} - {p}_{i , j - 1} ) - {\sum }_{j = 1}^{m} ( {p}_{i - 1 , j} - {p}_{i - 1 , j - 1} ) \} \\ = {\sum }_{i = 1}^{n} \{ ( {P}_{i , m} - {P}_{i , 0} ) - ( {P}_{i - 1 , m} - {P}_{i - 1 , 0} ) \} \\ = {\sum }_{i = 1}^{n} \{ ( {P}_{i , m} - {P}_{i - 1 , m} ) - ( {P}_{i , 0} - {P}_{i - 1 , 0} ) \} \\ = ( {P}_{n , m} - {P}_{0 , m} ) - ( {P}_{n , 0} - {P}_{0 , 0} ) \\ = {P}_{n , m} - {P}_{n - 1 , M}\end{matrix} \qquad ( 3 )$$

Here, the formula (2) is applied to {P0, 0, Pn, 0, P0, m} appearing in the formula. From this formula, the pixel value Pn, m before two-dimensional differential encoding is represented as the formula (4) below.

$${P}_{n , m} = {\sum }_{i = 1}^{n} {\sum }_{j = 1}^{m} {X}_{i , j} + {P}_{n - 1 , M} \qquad ( 4 )$$

In the personal computer 4 illustrated in FIG. 1, first, the pixel values P1, 1, P1, 2, . . . P1, M in the first line are obtained by using the above formula (4). For example, the m-th pixel value in the main scanning direction in the first line is represented as the formula (5) below by assigning n=1 to the above formula (4) and further using P0, M=0 of the formula (2).

$${P}_{1 , m} = {\sum }_{j = 1}^{m} {X}_{1 , j} \qquad ( 5 )$$

In this way, all the pixel values P1, 1, P1, 2, . . . P1, M in the first line are obtained.

Like the above, the pixel values P2, 1, P2, 2, . . . P1, Min the second line are obtained by assigning n=2 to the above formula (4) and further using P1, M obtained by duplicating the pixel value in the first line. For example, the m-th pixel value in the main scanning direction in the pixel values in the second line is represented as the formula (6) below.

$${P}_{2 , m} = {\sum }_{j = 1}^{m} ( {X}_{1 , j} + {X}_{2 , j} ) + {P}_{1 , M} \qquad ( 6 )$$

In the same way as the above, the pixel values in the third line and further lines can be obtained by using a duplicated pixel value in the above formula (6) and calculations after the formula (6). In the personal computer 4 illustrated in FIG. 1, data decompression processing is performed by a method like the above.

In the differential encoding section 510 in FIG. 1, the two-dimensional differential encoding as described above is performed on the image data. The data obtained by the two-dimensional differential encoding is inputted into the offset section 520 of FIG. 1, a predetermined offset value is added to each numeral of the data, and the data is divided into the least significant sub-plane D1L and the most significant sub-plane D1H. Here, the process until the data is divided will be described using a specific image as an example.

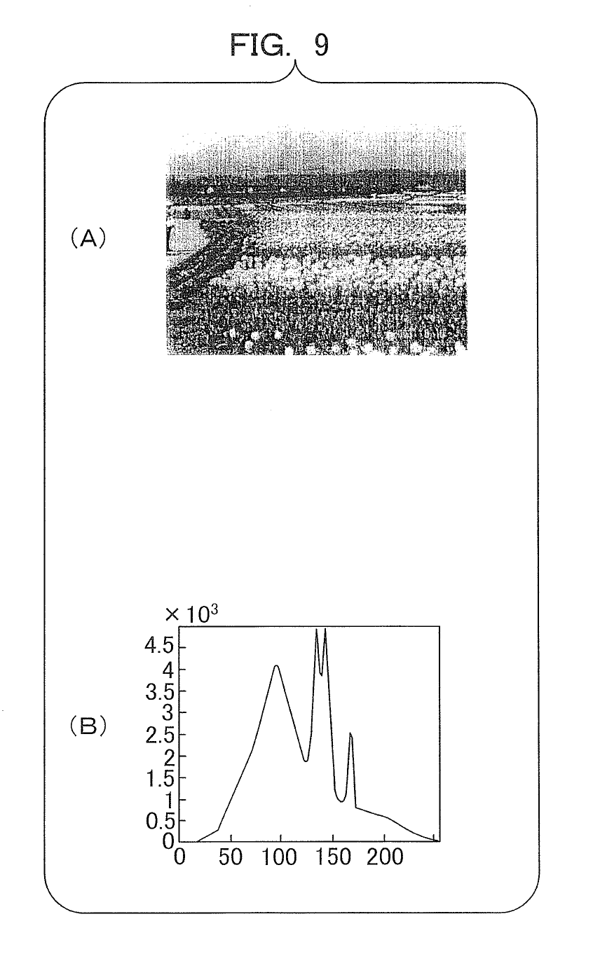

FIG. 9 is a drawing illustrating an example of an image data.

In part (A) of FIG. 9, a monochrome landscape image is illustrated, and in this embodiment as an example of an image, an image data in which a color density of each pixel of the image is represented by a 8-bit numeral is used. In part (B) of FIG. 9, a histogram of data values representing the landscape image illustrated in part (A) is illustrated. The horizontal axis of the histogram shows the data value, and the vertical axis shows the number of data (the number of pixels). In a usual image, a width of the histogram is wide, and even though there are peaks and valleys of the number of data in the histogram, it is extremely rare that a “0” area of the number of data appears between the left and right edges of the histogram.

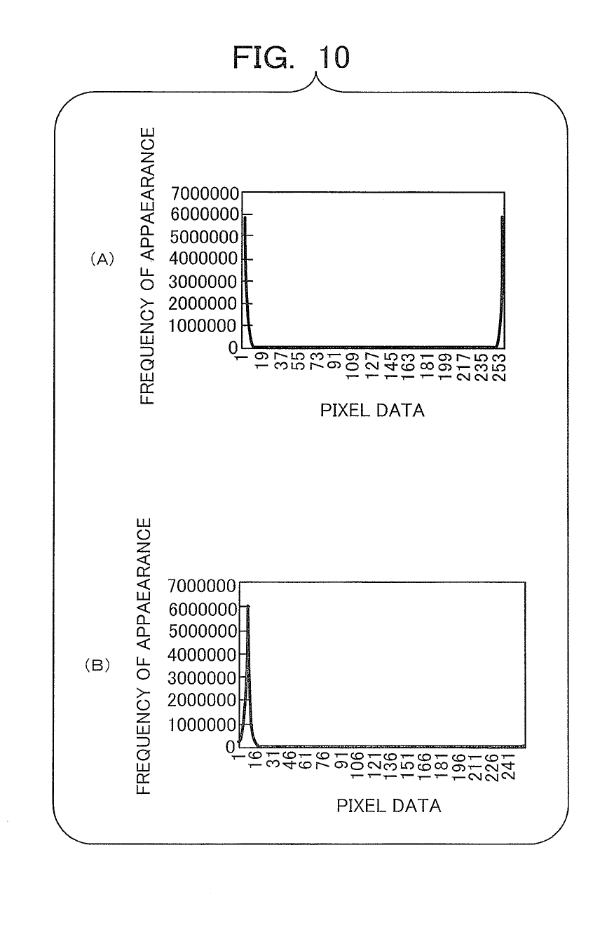

FIG. 10 is a drawing illustrating effects of the differential encoding and the offset for the image data.

In part (A) of FIG. 10, a histogram of data obtained by performing a differential encoding on the image data illustrated in FIG. 9 is illustrated. The horizontal axis of the histogram shows the data value, and the vertical axis shows a frequency of appearance. When the differential encoding described with reference to FIG. 6 and FIG. 7 is performed on the image data, the histogram of the data generally becomes a histogram having sharp peaks at both of the minimum data value and the maximum data value as illustrated in part (A) of FIG. 10. When the offset is performed on these data, the histogram of the data becomes a histogram having a sharp peak at the offset value as illustrated in part (B) of FIG. 10. In this embodiment, “8” is used as the offset value, and after the offset is performed on the data, the frequency of appearance of data having a value of “16” or more is nearly “0”.

The data having a histogram transformed by the differential encoding and the offset is divided into the least significant sub-plane D1L and the most significant sub-plane D1H by the plane division section 530 of FIG. 1.

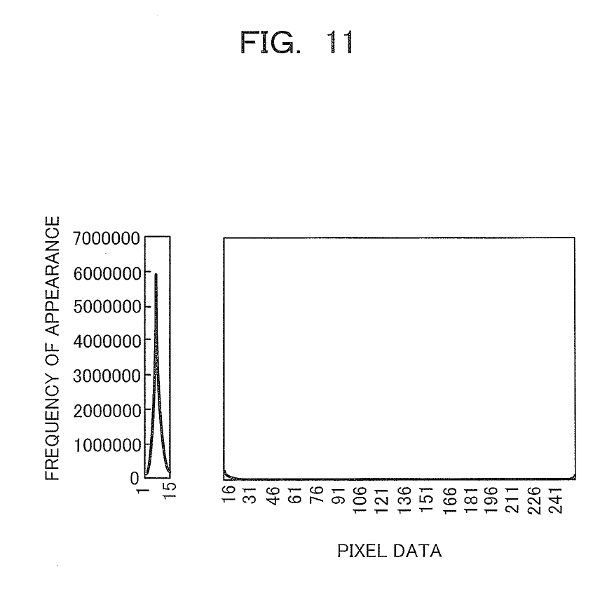

FIG. 11 is a diagram illustrating an effect of dividing data by the plane division section 530.

In FIG. 11, divided histograms made by dividing the histogram illustrated in part (B) of FIG. 10 along a line between the data value “15” and the data value “16” are illustrated, and the data division by the plane division section 530 of FIG. 1 actually generates an effect corresponding to this histogram division. Specifically, in this embodiment, 8-bit numerals of the data are divided into the most significant 4 bits and the least significant 4 bits, so that the least significant sub-plane D1L including a series of numerals represented by the least significant 4 bits and the most significant sub-plane D1H including a series of numerals represented by the most significant 4 bits are obtained. When understanding that the 4-bit numerals of the least significant sub-plane D1L directly represent numerals of values from “0” to “15”, and the 4-bit numerals constituting the most significant sub-plane D1H represent 16 kinds of numerals of values from “16” to “256” with an interval of “16”, the histogram of the least significant sub-plane D1L becomes approximately the same histogram as illustrated in the left side of FIG. 11 and the histogram of the most significant sub-plane D1H becomes approximately the same histogram as illustrated in the right side of FIG. 11. However, regarding the histogram of the most significant sub-plane D1H, a peak having a height equal to the area of the histogram illustrated in the left side of FIG. 11 is added to the position of the data value “16” in the histogram illustrated in the right side of FIG. 11.

Hereinafter, data processing after the data is divided into the most significant sub-plane D1H and the least significant sub-plane D1L will be described.

First, processing for the most significant sub-plane D1H will be described.

As apparent from the fact that a frequency of appearance of pixels is nearly zero in the histogram illustrated in the right side of FIG. 11, it is expected that there are many series of near zero values (“00”, “01”, “FF” in hexadecimal) in numerals of the most significant sub-plane D1H. Therefore, to perform compression on the most significant sub-plane D1H, the run length coding which performs compression by encoding a series of same numerals is effective, and the most significant sub-plane D1H is inputted into the run length coding section 551 which is one of the configuration elements of the H plane compression section 550 illustrated in FIG. 1.

In this embodiment, for convenience of processing, two successive 4-bit numerals constituting the most significant sub-plane D1H are treated as one 8-bit numeral in the run length coding section 551, and an encoding processing below is performed on a series of numerals having values from “00” to “FF” in hexadecimal.

In this encoding processing, only specific numerals in multiple 8-bit numerals are encoded. Therefore, in the run length coding section 551, numerals to be encoded (here, this numeral is called “compression target numeral”) and the number of a series of the same compression target numerals are detected in the received data.

In this embodiment, for an example, three numerals “01”, “FF”, and “00” are defined as the compression target numerals.

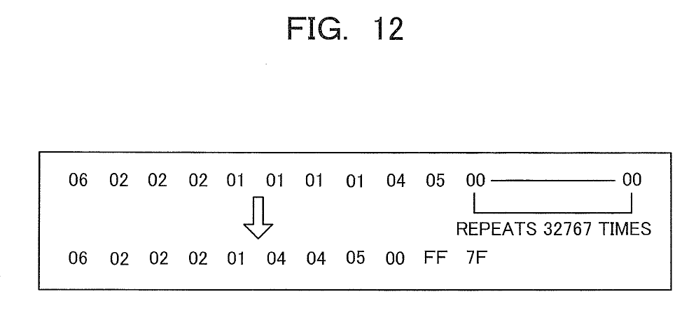

FIG. 12 is a diagram illustrating the encoding in the run length coding section 551 illustrated in FIG. 1.

In FIG. 12, the upper line shows data constituting the most significant sub-plane D1H, and the lower line shows data which has been encoded in the run length coding section 551.

Here, as illustrated in the upper line of FIG. 12, it is assumed that data “06 02 02 02 01 01 01 01 04 05 00 . . . ” are inputted from the run length coding section 551. At this time, in the run length coding section 551 of FIG. 1, it is detected that the top “06” is not a compression target numeral, the next “02 02 02” are not compression target numerals either, next, there are four successive “01” which is a compression target numeral, next, there are “04 05” which are not compression target numerals, and then there are 32767 successive “00” which are compression target numerals.

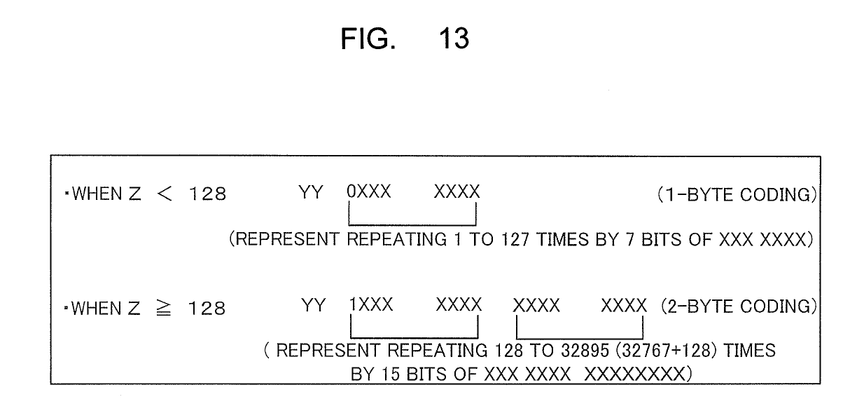

FIG. 13 is a drawing illustrating an encoding algorithm for the compression target numerals in the run length coding section.

In FIG. 13, Z is the number of successive numerals of the same compression target numeral, for example, Z=4 for “01” in the upper line of FIGS. 12, and Z=32767 for “00”.

In FIG. 13, “YY” shows a compression target numeral itself represented by 2 hexadecimal digits. The numeral “0” or “1” succeeding the “YY” is “0” or “1” represented by 1 bit, one “X” of “XXX XXXX . . . ” succeeding the “0” or “1” represents 1 bit, and this “XXX XXXX . . . ” represents the value of Z.

Specifically, FIG. 13 means that when the compression target numeral “YY” repeats Z (Z<128) times, the first byte represents the compression target numeral “YY” and the succeeding 1 byte in which the top bit is “0” represents the value of Z using 7 bits succeeding the top bit, and when the compression target numeral “YY” repeats Z (n128) times, the first byte represents the compression target numeral “YY” and the succeeding 2 bytes (16 byte) in which the top bit is “1” represent that the 2 bytes shows the value of Z and the value of Z is represented by 15 bits following the top bit.

An example of the encoding illustrated in FIG. 12 will be described according to the rule illustrated in FIG. 13.

Since the top numeral “06” constituting data (upper line) of the most significant sub-plane D1H inputted from the plane division section 530 of FIG. 1 is not a compression target numeral, the “06” is outputted without change. Regarding the succeeding “02 02 02”, the “02” is not a compression target numeral either, and these three “02” are also outputted without change. Next, the compression target numeral “01” repeats four times, the four “01” are encoded into “01 04”. Since the succeeding “04” and “05” are not compression target numerals, the “04 05” are outputted without change.

Next, since “00” repeats 32767 times, “00” is placed, “1” is set to the top bit of the next byte, and the 15 bits succeeding the top bit represent 32767-128, so that the three bytes of “00 FF 7F” represent that “00” repeats 32767 times. In other words, the repeating times 128 is represented by “00 00” except for the first bit “1”.

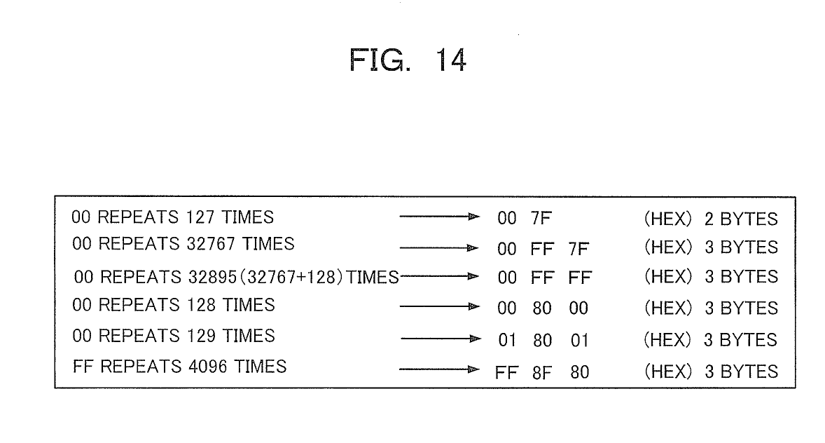

FIG. 14 is a drawing illustrating an example of the encoding processing corresponding to the repeating times in the run length coding section 551 of FIG. 1.
When “00” repeats 127 times, they are encoded into “00 7F” using 2 bytes,
When “00” repeats 32767 times, they are encoded into “00 FF 7F” using 3 bytes,
When “00” repeats 32895 times, they are encoded into “00 FF FF” using 3 bytes,
When “00” repeats 128 times, they are encoded into “00 80 00” using 3 bytes,
When “01” repeats 129 times, they are encoded into “01 80 01” using 3 bytes, and
When “FF” repeats 4096 times, they are encoded into “FF 8F 80” using 3 bytes.

In the run length coding section 551 illustrated in FIG. 1, the encoding processing described above is performed.

According to the run length coding section 551 of this embodiment, the maximum compression ratio is improved to 3/32895=1/10,965. In addition, in the data of the most significant sub-plane D1H which is a target of the encoding processing of the run length coding section 551, as described with reference to the histogram of FIG. 11, most of the 4-bit numerals are “0” representing a data value “16”, and many of the 8-bit numerals made from the 4-bit numerals become “00” in hexadecimal notation. Therefore, significant data compression can be expected by the encoding processing in the run length coding section 551.

Next, the data on which the above encoding processing has been performed in the run length coding section 551 in the H plane compression section 550 of FIG. 1 is inputted into the data scanning section 552 and the Huffman coding section 553 of the H plane compression section 550 of FIG. 1.

In the data scanning section 552, first, all the data outputted from the run length coding section 551 are scanned to obtain the frequency of appearance of the data values.

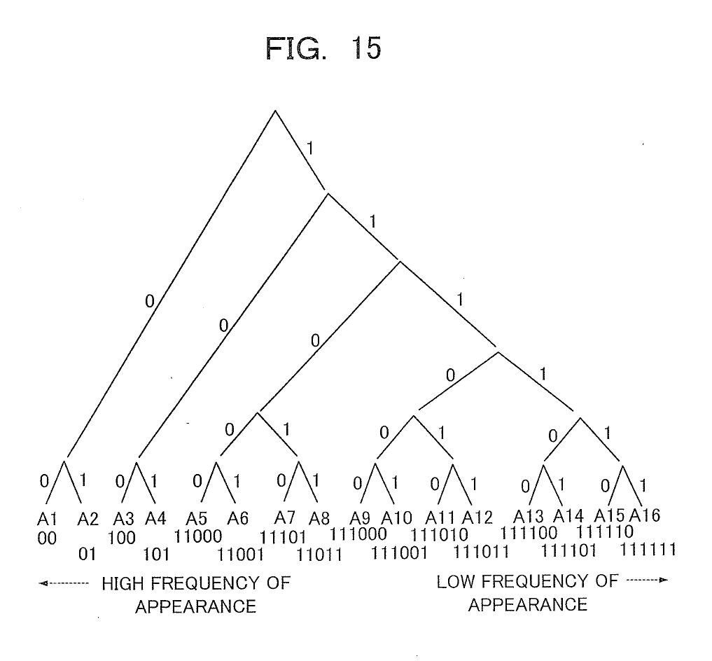

FIG. 15 is a drawing illustrating an example of the scanning result of the data scanning section 552.

Here, it is assumed that the frequency of appearance of “A1” is the highest, followed by “A2”, “A3”, “A4” in order. These “A1”, “A2” and the like do not directly represent a numeral, but they are symbols representing a numeral. Specifically, for example, “A1” represents a numeral “00”, “A2” represents a numeral “FE”, and so on. Here, for the sake of simplicity, it is assumed that all the data values of the data transmitted from the run length coding section 551 of FIG. 1 are any one of the 16 numerals “A1” to “A16”. In the data scanning section 552, a code corresponding to the frequency of appearance of a numeral is assigned to each of these 16 numerals, so that the Huffman table is created. Specifically, a code “00” represented by 2 bits is assigned to “A1” having the highest frequency of appearance, a code “01” also represented by 2 bits is assigned to the next “A2”, a code “100” and a code “101” which are represented by 3 bits are assigned to the next “A3” and further next “A4” respectively, and codes represented by 5 bits are assigned to the next “A5” to “A8”. In the same way, for the following numerals, the smaller the frequency of appearance of the numeral is, the greater the number of bits representing a code which is assigned to the numeral is.

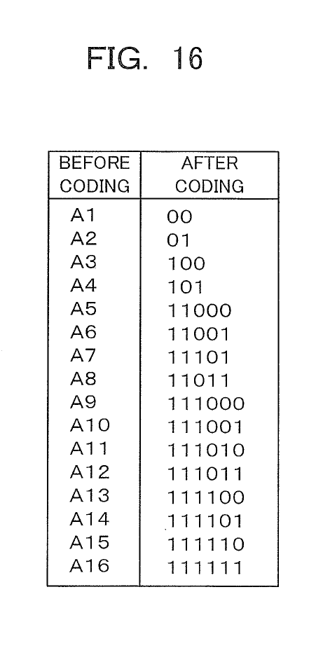

FIG. 16 is a drawing illustrating an example of the Huffman table.

This Huffman table corresponds to FIG. 15, and is a relationship table of the pre-encoding (before replacement) numerals and the post-encoding numerals (after replacement) in which numerals having higher frequency of appearance are replaced by codes represented by a smaller number of bits. The higher the frequency is, the smaller the number of bits.

In the Huffman coding section 553 of the H plane compression section 550 of FIG. 1, numerals of the data are encoded according to such Huffman table, so that many numerals are replaced by codes having a smaller number of bits and the data compression is realized.

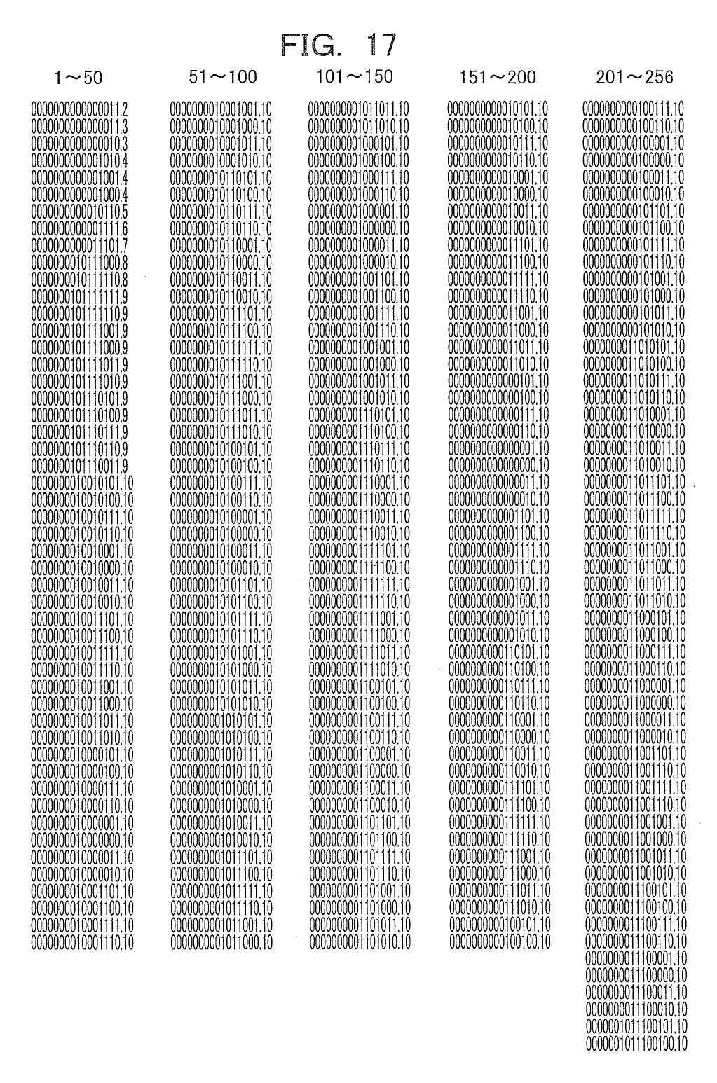

FIG. 17 is a drawing illustrating a specific example of a code arrangement prepared for the Huffman table.

In the code arrangement illustrated in FIG. 17, the numerals in the right side of “,” in the code arrangement mean the bit-length, and the binary codes arranged in the left side of the “,” having the corresponding bit-length represent the actual codes. For example, the first code at the upper left of FIG. 17 is 2 bits of “11”, the next second code is 3 bits of “011”, the next third code is 3 bits of “010”, and the further next fourth code is 4 bits of “1010”. By using such code arrangement, a numeral having higher frequency of appearance is replaced by a code having a smaller number of bits. The higher the frequency, the smaller the number of bits.

By the processing described with reference to the above FIG. 12 to FIG. 17, regarding the most significant sub-plane D1H inputted into the H plane compression section 550 of FIG. 1, the encoding by the run length coding section 551 and the encoding by the Huffman coding section 553 are performed, so that the most significant sub-plane D1H is compressed at high compression ratio to be the most significant compressed data D2H.

Next, processing for the least significant sub-plane D1L will be described. The Huffman coding processing described with reference to FIGS. 15 to 17 is performed on the least significant sub-plane D1L which is divided in the plane division section 530, in the data scanning section 543 and the Huffman coding section 541 of the L plane compression section 540. The least significant sub-plane D1L after the Huffman coding is outputted from the L plane compression section 540 as the least significant compressed data D2L. As mentioned above, when the high-speed mode is instructed by a user, the Huffman coding processing by the Huffman coding section 541 is omitted, and the least significant sub-plane D1L is outputted from the L plane compression section 540.

Next, the lossy compression processing for the FAKE pixel data will be described. The FAKE pixel data obtained in the thinning-out processing section 505 is inputted into the FAKE pixel data compression section 560, and the bit shortening section 561 in the FAKE pixel data compression section 560 encodes the FAKE pixel data into 4-bit or 1-bit data depending on whether the FAKE pixel data is an edge portion pixel data or not. Whether the FAKE pixel data is an edge portion pixel data or not is determined by the edge detection section 525 of FIG. 1 on the basis of the differential data after the offset by the offset section 520.

Next, the operation in which the FAKE pixel data is encoded will be described.

When representing a pixel value of a TRUE pixel illustrated in FIG. 4 as Tn_k, the pixel values of FAKE pixels next to the TRUE pixel are represented as Fn_k+1, Fn+1_k, Fn+1_k+1, and the pixel values of TRUE pixels located next to the above TRUE pixel with these FAKE pixels sandwiched in between are represented as Tn_k+2, Tn+2_k, Tn+2_k+2. In the edge detection section 525, the pixel values of the above three FAKE pixels Fn_k+1, Fn+1_k, Fn+1_k+1 are determined to be an edge portion when the differential value (here, the differential value is not represented by values from “00” to “FF” in hexadecimal notation like the above, but represented by a decimal number obtained by directly taking a difference of pixel values) obtained from the pixel values Tn_k, Tn_k+2, Tn+2_k, Tn+2_k+2 of these 4 TRUE pixels by two-dimensional differential encoding processing belongs to a range smaller than (−L) or a range greater than or equal to (+L) which are defined using a positive integer threshold parameter L set in the edge detection section 525, and the pixel values of the above three FAKE pixels are encoded into a 4-bit code stating from “1” in the bit shortening section 561.

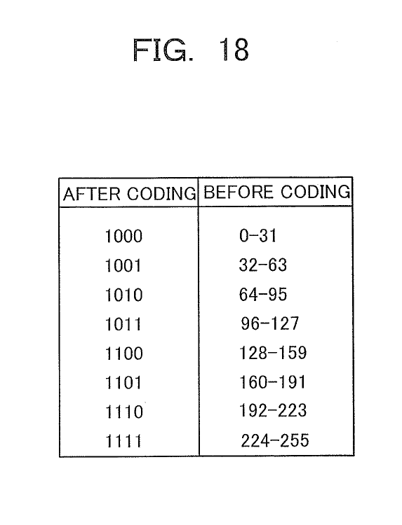

FIG. 18 is a drawing illustrating an encoding method to 4-bit codes.

In this encoding method, pixel values of FAKE pixels are encoded into codes from “1000” to “1111” by cutting off the least significant 5 bits from a 8-bit value representing the pixel value and adding “1” to the top of the remaining 3 significant bits. Therefore, as illustrated in the table of this figure, the numerals “0” to “31” of “0” to “255” before encoding are encoded into “1000”, and the numerals “22 to “63” are encoded into “1001”. In the same way, the numerals “64” to “95”, “99” to “127”, “128” to “159”, “160” to “191”, “192” to “223”, and “224” to “225” are encoded into “1010”, “1011”, “1100”, “1101”, “1110”, and “1111”, respectively. Such encoding method is realized by a very simple processing of cutting off digits of bit value. By such a method of encoding to 4-bit code, the information of original image is maintained to some extent and deterioration of the image quality is avoided.

In the edge detection section 525, the pixel values of the above three FAKE pixels Fn_k+1, Fn+1_k, Fn+1_k+1 are determined not to be an edge portion when the differential value obtained from the pixel values Tn_k, Tn_k+2, Tn+2_k, Tn+2_k+2 of the above 4 TRUE pixels by two-dimensional differential encoding processing belongs to a range greater than (−L) and smaller than or equal to (+L), and the pixel values of the above three FAKE pixels are encoded into a 1-bit code, “0” in the bit shortening section 561.

On the data replaced by codes of 1 bit or 4 bits, the same processing as that of the H plane compression section 550 is performed by the run length coding section 562 and the Huffman coding section 563. Here, although there is also a data scanning section which works in the same way as the data scanning section 552 of the H plane compression section 550 in the FAKE pixel compression section 560, the data scanning section of the FAKE pixel compression section 560 is omitted in FIG. 1. The FAKE pixel data on which the run length coding processing and the Huffman coding processing are performed is outputted from the FAKE pixel data compression section 560 as the lossy compressed data D3.

Compressed data in which lossy compression processing is performed on the original image data is formed, by a combination made of the least significant compressed data D2L and the most significant compressed data D2H outputted respectively from the L plane compression section 540 and H plane compression section 550, and further joined by the lossy compressed data D3. And by using a series of compressed data on which the lossy compression processing is performed, compressed moving picture data in which the lossy compression processing is performed on the original moving picture is formed.

1.-17. (canceled)

18. A moving picture compression apparatus comprising:
a thinning-out processing section which, by selectively taking out numerals from a series of numerals of each image data constituting a compression target data that represents a moving picture by a series of image data each of which represents a still image by a series of numerals, creates a first data comprising a series of numerals which are selectively taken out and a second data comprising a series of remaining numerals for each image data, and shifts positions of numerals which are selectively taken out on the still image from corresponding positions in a temporally adjacent still image;
a first compression section which performs lossless compression on the first data; and
a second compression section which performs lossy compression on the second data.

19. The moving picture compression apparatus according to claim 18, wherein when the thinning-out processing section selectively takes out numerals, the thinning-out processing section selectively takes out numerals corresponding to positions forming a periodic arrangement on the still image, and the thinning-out processing section does not change a periodicity of the arrangement but changes a phase of the arrangement on a temporally adjacent still image.

20. The moving picture compression apparatus according to claim 18, wherein when the thinning-out processing section selectively takes out numerals, the thinning-out processing section selectively takes out numerals corresponding to positions forming a two-dimensional periodic arrangement on the still image, the thinning-out processing section does not change a periodicity of the arrangement but changes a phase of the arrangement on a temporally adjacent still image, and the thinning-out processing section makes the positions corresponding to the numerals selectively taken out on the still image go around on the still image every predetermined number of image data.

21. The moving picture compression apparatus according to claim 18, wherein the first compression section comprises a difference generation section which, by obtaining differences between numerals next to each other in a series of numerals included in the first data, generates differential data including a series of numerals representing the differences, and the first compression section performs a lossless compression on the differential data generated by the difference generation section.

22. The moving picture compression apparatus according to claim 18, wherein the first compression section comprises a difference generation section which, by obtaining two-dimensional differences based on multiple numerals adjacent to a numeral in multiple directions on the still image, the numeral being included in the first data, generates differential data including a series of numerals representing the differences, and the first compression section performs a lossless compression on the differential data generated by the difference generation section.

23. The moving picture compression apparatus according to claim 18, wherein an image data included in the compression target data is formed by a series of numerals represented by a predetermined number of unit bits, and the second compression section comprises:
a determination section which determines an edge portion in the still image; and
a data conversion section which outputs a predetermined code having a number of bits smaller than the number of unit bits when a numeral included in the second data generated in the thinning-out processing section is not the edge portion determined by the determination section, and outputs a numeral represented by a small number of bits smaller than or equal to the number of unit bits when the numeral included in the second data is the edge portion.

24. The moving picture compression apparatus according to claim 23, wherein the data conversion section truncates the least significant digits of the bit value of the number of unit bits when representing a numeral by using the small number of bits.

25. The moving picture compression apparatus according to claim 21, wherein the difference generation section generates differential data including a series of numerals representing the difference by a predetermined number of unit bits as the differential data, and the first compression section comprises:
an offset section which offsets each numeral included in differential data generated by the difference generation section by a predetermined value;
a division section which, by dividing each numeral offset by the offset section into the most significant bits and the least significant bits at a predetermined number of division bits smaller than the number of unit bits, divides the data into the most significant data including a series of the most significant bit portion of each numeral and the least significant data including a series of the least significant bit portion of each numeral; and
a most significant data compression section which performs a lossless compression processing on the most significant data divided by the division section.

26. The moving picture compression apparatus according to claim 22, wherein the difference generation section generates differential data including a series numerals representing the difference by a predetermined number of unit bits as the differential data, and the first compression section comprises:
an offset section which offsets each numeral included in differential data generated by the difference generation section by a predetermined value;
a division section which, by dividing each numeral offset by the offset section into the most significant bits and the least significant bits at a predetermined number of division bits smaller than the number of unit bits, divides the data into the most significant data including a series of the most significant bit portion of each numeral and the least significant data including a series of the least significant bit portion of each numeral; and
a most significant data compression section which performs a lossless compression processing on the most significant data divided by the division section.

27. The moving picture compression apparatus according to claim 25, wherein the most significant data compression section comprises a first encoding section which directly outputs numerals in the most significant data except for one or more predetermined number of the compression target numerals, and outputs compression target numerals after encoding the compression target numerals into the compression target numeral and a numeral representing the number of a series of the same numerals as the compression target numeral.

28. The moving picture compression apparatus according to claim 25, wherein the most significant data compression section comprises:
a first encoding section which directly outputs numerals in the most significant data except for one or more predetermined number of the compression target numerals, and outputs compression target numerals after encoding the compression target numerals into the compression target numeral and a numeral representing the number of a series of the same numerals as the compression target numeral; and
a second encoding section which performs, by using a table which associates codes with numerals, an entropy coding on the data which has been encoded in the first encoding section.

29. The moving picture compression apparatus according to claim 25, wherein the most significant data compression section comprises:
a first encoding section which directly outputs numerals in the most significant data except for one or more predetermined number of the compression target numerals, and outputs compression target numerals after encoding the compression target numerals into the compression target numeral and a numeral representing the number of a series of the same numerals as the compression target numeral; and
a second encoding section which performs, by using a Huffman table, a Huffman coding on the data which has been encoded in the first encoding section.

30. The moving picture compression apparatus according to claim 25, wherein the most significant data compression section comprises:
a first encoding section which directly outputs numerals in the most significant data except for one or more predetermined number of the compression target numerals, and outputs compression target numerals after encoding the compression target numerals into the compression target numeral and a numeral representing the number of a series of the same numerals as the compression target numeral;
a histogram estimation section which obtains a histogram of numerals appearing in the data which has been encoded in the first encoding section;
a code assignment section which assigns numerals and codes to a table which associates the numerals with the codes, in a condition in which the higher a frequency of appearance of the numeral is, the shorter a length of the code is, based on the obtained histogram; and
a second encoding section which performs, by using the table in which codes are assigned in the code assignment section, an entropy coding on the data which has been encoded in the first encoding section.

31. The moving picture compression apparatus according to claim 25, further comprising a least significant data compression section which performs a lossless compression on the least significant data divided in the division section.

32. The moving picture compression apparatus according to claim 31, wherein the least significant data compression section performs an entropy coding on the least significant data by using a table which associates numerals with codes.

33. The moving picture compression apparatus according to claim 31, wherein the least significant data compression section performs a Huffman coding on the least significant data by using a Huffman table.

34. The moving picture compression apparatus according to claim 31, wherein the least significant data compression section outputs the least significant data without compression by receiving an instruction to omit compression.

35. A storage medium that stores a moving picture compression program which is installed in an information processing apparatus to construct:
a thinning-out processing section which, by selectively taking out numerals from a series of numerals of each image data constituting a compression target data representing a moving picture by a series of image data each of which represents a still image by a series of numerals, makes a first data comprising a series of numerals which are selectively taken out and a second data comprising a series of remaining numerals for each image data, and shifts positions of numerals which are selectively taken out in the still image from corresponding positions in a temporally adjacent still image;
a first compression section which performs a lossless compression on the first data; and
a second compression section which performs a lossy compression on the second data.
